(19) United States
(12) Patent Application Publication
(10) Pub. No.: US 2025/0124363 A1
(43) Pub. Date: Apr. 17, 2025

(54) CONTAINER PACKING USING ENHANCED QUANTUM ANNEALING METHODS

(71) Applicant: Unisys Corporation, Blu Bell, PA (US)

(72) Inventors: Deepak HONNALLI, Bengaluru (IN); William Mather Almon CARSCALLEN, Blue Bell, PA (US); Tushar Satyendra SASHITTAL, Blue Bell, PA (US)

(21) Appl. No.: 18/646,468

(22) Filed: Apr. 25, 2024

(30) Foreign Application Priority Data
Oct. 16, 2023 (IN) 202311070270

(51) Int. Cl. G06Q 10/04

(52) U.S. Cl. CPC G06Q 10/04

(57) ABSTRACT

To determine an optimal packing arrangement of packages within containers for shipment, quantum annealing methods can be used and enhanced by sub-optimization problems. Container data and packages data can be divided into sub-optimization problems by grouping packages with, for example, a common destination. Objectives and constraints are determined for each of the sub-optimization problems. The sub-optimization problems are annealed asynchronously. The output solutions can be combined and provided as a combined solution, which in an example aspect, is used to render a three-dimensional illustration of the packing arrangement of the packages in the containers.

### CROSS-REFERENCE TO RELATED APPLICATIONS

This application claims the benefit of priority to Indian Patent Application number 202311070270, filed in the Indian Patent Office on Oct. 16, 2023, and entitled “Container Packing Using Enhanced Quantum Annealing Methods,” the contents of which are hereby incorporated by reference in their entirety.

### BACKGROUND

In the fields of logistics and transportation, packages must be arranged within containers for shipping. When determining how to arrange packages within a container, one must identify the optimal balance between optimizing space utilization, ensuring balanced weight distribution, facilitating ease of loading and unloading, ensuring inter-package compatibility, and more. These objectives, in turn, depend on numerous variables, such as the dimensions and shapes of the packages and the interior dimensions of the container.

### SUMMARY

The technology described herein relates to optimal packing of containers. In a specific implementation, the technology relates to the optimal packing of containers having different dimensions.

In an example, container data is accessed. The container data may include a number of containers and the volume of the containers, for instance. In some cases, the number of slots for a vehicle(s) into which containers are placed is determined. The package data includes the dimensions and the weight of the packages to be arranged. Using this information, the number of containers for which to generate optimal arrangements is determined.

A series of sub-optimization problems is generated. In an aspect, this is based on at least a common destination location. In another aspect, this is based on the number of containers for which to generate optimal arrangements. Constraints and objectives are applied to each sub-optimization problem of the series. Each sub-optimization problem can be annealed to generate an optimal arrangement. A quantum annealer may be invoked to asynchronously anneal each sub-optimization problem to generate a solution for each sub-optimization problem.

In some aspects, a combined solution is generated identifying optimal packing arrangement of the packages within the containers.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an operating environment in which aspects of the technology may be implemented, in accordance with an aspect described herein;

FIG. 2 illustrates a flowchart of an example process that can be implemented by the technology, in accordance with an aspect described herein;

FIG. 3 illustrates an example method for generating an optimal solution for an arrangement of packages in a container, in accordance with an aspect described herein;

FIG. 4 illustrates an example quantum annealer suitable for use with the present technology, in accordance with an aspect described herein;

FIG. 5 illustrates an example quantum annealing process the may be performed by the quantum annealer of FIG. 4, in accordance with an aspect described herein; and

FIG. 6 illustrates an example computing device suitable for implementing aspects of the present technology, in accordance with an aspect described herein.

### DETAILED DESCRIPTION

As used herein, a vehicle generally refers to a mode of transportation used to deliver an object, such as a container, from one location to another. The primary mediums through which vehicles operate include air, ground, and sea, each having a range of vehicles suited for different types of deliveries. For example, aircraft, drones, helicopters, delivery vans, trucks, trains, motorbikes or bicycles, automated ground vehicles, container ships, ferries, cruise liners, barges, and more are all example vehicles suitable for carrying objects between locations.

A container generally refers to a pallet or object, whether enclosed or partially enclosed, used to load and secure packages for transportation on a vehicle, such as air, sea, or ground vehicles. Containers often serve as a standardized, and sometimes reusable structure, that facilitates the organized, efficient, and secure handling the packages. In some cases, a container may include a portion of a vehicle, such as if the boundaries of the vehicle itself serve as the container in which packages are directly placed.

Also as used herein, a package refers to an item or a group of items designated to be transported from one location to another. The term package encompasses any unit or container for transit, including a single unit or a group of units secured together. Packages may have package restrictions associated with the packages.

Containers in the field of logistics help facilitate the standardized consolidation and transportation of packages using various vehicle platforms including air, sea, and ground vehicles. Their structure is designed to house packages securely, providing a stable and organized way to handle, load, and unload their contents, thereby enhancing the efficiency of transit processes across different modes of transportation.

Packages often must be loaded into containers to be shipped. Given the limited amount of space available in such containers, it is important to select and arrange packages in a manner that maximizes space utilization. Inefficient space utilization results in additional unnecessary routes or vehicles needed to transport the package. However, this task is so complex that it is often impossible to perform even with significant computational resources.

To illustrate, suppose there are 30 packages to be distributed between 3 containers. In this case, there are 330-more than 205 trillion-possible ways to distribute the packages between the containers. But even this characterization significantly understates the task's complexity. First, in practice, there are often far more packages and containers. Second, each package must be positioned within its container, both rotationally and along x-y-z coordinates. Third, some packages are not compatible with other packages (e.g., a flammable package and an explosive package), and some packages are not compatible with some containers. Fourth, packages generally vary in shape, size, and weight. Due in part to such variations, many possible packing configurations are unstable. Fifth, in a commercial context, a shipper's business objectives must be taken into account. For example, packages should be delivered in a timely manner, and “priority” packages should generally be shipped before non-priority packages. In another example, packages that are destined to go to one offload location should be grouped together as much as possible to minimize rebuilding the container. In some instances, these requirements may contradict one another and may need to be weighted to resolve conflicts.

Heuristic and metaheuristic methods for solving packing optimization have shown reasonable success for small to medium-sized instances. However, as the problem grows, classical algorithms' computation time and memory requirements increase exponentially, making them impractical for large-scale packing optimization instances commonly encountered in real-world scenarios.

The emergence of quantum computing has opened new avenues for tackling complex optimization problems like packing optimization. Quantum computing leverages the principles of quantum mechanics to perform computations on quantum bits (qubits), allowing for parallelism and exploiting quantum phenomena such as superposition and entanglement to explore potential solutions more efficiently.

Solutions to the problem are limited or undiscoverable with many existing conventional computational methods. This is in part due to vast search spaces (e.g., an extremely large solution domain with many possible candidate solutions), significant solution times due to computational limitations, and discovery of relatively low-quality solutions of all of the possible solutions in the solution space.

Some conventional approaches use exact algorithms and aim to find the optimal solution by systematically exploring the entire solution space. They guarantee to find the best solution, but their computational complexity often limits their application to small or moderately sized instances, and cannot be scaled with the size of the solution space, which as noted, is an exponential growth, effectively limiting these methods to only minor applications.

Other conventional methods use heuristic algorithms. Such conventional algorithms are designed to find good-quality solutions quickly but do not guarantee optimality. They use efficient strategies to explore the solution space, which makes them suitable for larger instances. However, these methods can take significantly long computational times. Moreover, some attempted solutions use metaheuristics. Metaheuristics are higher-level procedures that guide the search process to navigate the solution space. They are relatively more flexible. However, one of the problems with this approach is that it is not guaranteed to reach an optimal solution.

To overcome these challenges, the technology described herein determines (a) which packages to load into containers and (b) how to arrange packages within each container in a manner that is computationally efficient, maximizes packing density, and adheres to operational constraints. More particularly, the technology comprises a container optimizer that employs a quantum annealer to optimize a packing solution. In an example, input to a container optimizer includes a vehicle identifier (e.g., a flight number), a type of container the vehicle supports (e.g., the size, shape, and volume of the container, the number of available slots, etc.), and package information (e.g., dimensions, SPL code, package restrictions, offload location, etc.).

The container optimizer considers several constraints when generating an optimal arrangement of the packages into the available containers types that are supported for a particular vehicle: score of the package, which measures but is not restricted to the priority of the package (the greater the score, the more are the chances that it will be packed); package restrictions and whether they are compatible with container restrictions; orientation constraints; boundary constraints; weight and volume supported by the container; and the shape of the container.

Subject to the constraints, an example set of objectives the container optimizer attempts to solve may be to: minimize the number of containers required for packing; maximize the revenue of the packages (as measured by the score); and arrange heavier packages at the bottom of the containers. The determination of the optimal packing arrangement can be considered an NP-Hard problem. The computational complexity of an NP problem is the amount of time it would take for a computer to solve the problem if the computer had unlimited resources. NP-complete problems are believed to be not solvable in polynomial time by any deterministic Turing machine.

As such, the container optimizer divides the optimization problem into several sub-optimization problems, subject to the constraints and objectives, and employs a quantum annealer to solve each sub-optimization problem asynchronously. The container optimizer combines the output of each sub-optimization problem into a build plan that facilitates real-world container packing.

In the context of quantum annealing, quantum annealers are generally limited by what can be considered a constraint density threshold. Constraint density refers to the complexity of the optimization problem in terms of the constraints and variables considered when solving the problem. The constraint density threshold involves considering the interplay between the annealer's hardware design and the nature of the optimization problem. This threshold reflects the maximum complexity level of a problem that the quantum annealer can handle effectively. More broadly, this refers to the operational limitation of the quantum annealer.

Central to the quantum annealer's capability is the number of qubits in the quantum annealer. The qubits are the core elements that represent the problem's variables, and their quantity and connectivity directly influence the size of the problem that can be addressed. The connectivity among qubits, dictated by the annealer's architecture, affects the problem mapping. This involves mapping the problem's variables and constraints onto the qubits and their interactions. Thus, as the complexity of a problem increases, the challenge of effectively embedding it into the annealer's structure also rises. If the problem's constraint density exceeds the annealer's capacity, efficient embedding could become impossible, leading to no solution or a sub-optimal solution.

The size of the search space, dictated by the constraint density, also plays a role. A higher constraint density typically means a larger and more complex search space, which can be challenging for the quantum annealer to explore effectively, given its finite number of qubits and limited connectivity. Put another way, because of the physical limitations of the qubits and their connectivity, precision of the solution found by a quantum annealer can be inversely related to the complexity of the problem. For simpler problems (low constraint density), the annealer can often find more precise solutions. For more complex problems (high constraint density), the precision may decrease, as the annealer may not be able to fully explore the vast search space, might become trapped in local minima, or experience negative complex qubit fluctuation. For problems that are even more complex, their constraint density could exceed the constraint density threshold of the quantum annealer, and thus, the problem may not be solvable at all.

The technology provided herein provides for a hybrid approach that uses both a classical computing device and quantum annealing to determine the most optimal container packing. A process employed by the classical computing device to reduce the search space enhances the quantum annealer's ability to solve for a more optimal packing solution to the problem that it otherwise would be able to given its limitations.

Reducing a problem's constraint density using classical computation before solving it with a quantum computer can significantly improve the quantum computer's ability to handle the problem, particularly due to hardware limitations of the quantum system. As noted, the effectiveness in solving a problem is largely dependent on how well the problem can be mapped onto the quantum hardware, which includes the number of qubits and their interconnectivity.

By using classical computers to reduce the search space, e.g., the constraint density, the complexity of the problem is lowered. A simpler problem with fewer constraints and variables is easier to map onto the quantum hardware. The quantum annealer can explore the search space more effectively. This is because simpler problems allow for a more thorough exploration within the hardware's limitations, thereby increasing the likelihood of finding optimal or near-optimal solutions.

In aspects of technology, a first set of constraints can be applied using the classical device, effectively reducing the number of constraints of the optimization problem solved by the quantum annealer, allowing for more variables to be processed by the annealer and a deeper solution space explored. In essence, the quantum annealer can effectively tackle more complex problems than it could without the initial use of the classical device. This synergy between classical and quantum expands the capabilities of quantum annealers, limited by their hardware and design. This reduction in complexity means that the quantum annealer, with its fixed number of qubits and specific qubit connectivity, can map and solve the problem more efficiently. In some complex cases, without the initial application of the classical device, the quantum annealer might be unable to handle the original problem complexity due to limitations such as insufficient qubit connectivity or the sheer number of variables and constraints, which can drive solutions to unstable and local minima regions.

The combined use of the classical device and the quantum annealer allows the quantum annealer to focus on a more tractable problem space. This not only improves the quality of solutions but also enables the quantum annealer to address a broader range of problems, including previously unsolvable problems that result from their inherent complexity. The reduced complexity leads to a more efficient exploration of the search space within the hardware's constraints, thereby enhancing the overall problem-solving capabilities of the quantum annealer.

It will be realized that the methods previously described are only examples that can be practiced from the description that follows and are provided to more easily understand the technology and recognize its benefits. Additional examples are now described with reference to the figures.

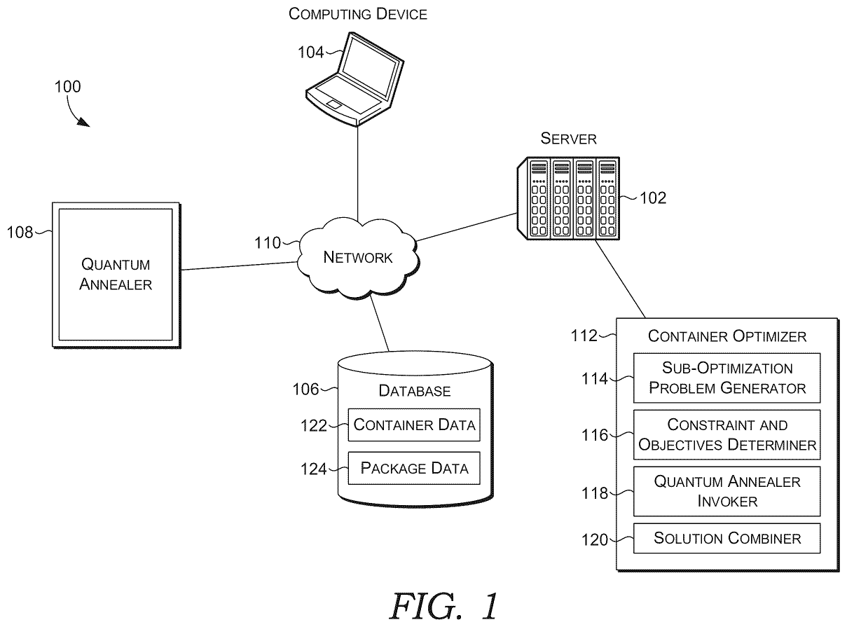

With reference now to FIG. 1, an example operating environment 100 in which aspects of the technology may be employed is provided. Among other components or engines not shown, operating environment 100 comprises server 102, computing device 104, database 106, and quantum annealer 108, which communicate via network 110.

Database 106 generally stores information, including data, computer instructions (e.g., software program instructions, routines, or services), or models used in embodiments of the described technologies. Although depicted as a single database component, database 106 may be embodied as one or more databases or may be in the cloud. In aspects, database 106 is representative of a distributed ledger network.

Network 110 may include one or more networks (e.g., public network or virtual private network [VPN]), as shown with network 110. Network 110 may include, without limitation, one or more local area networks (LANs), wide area networks (WANs), or any other communication network or method.

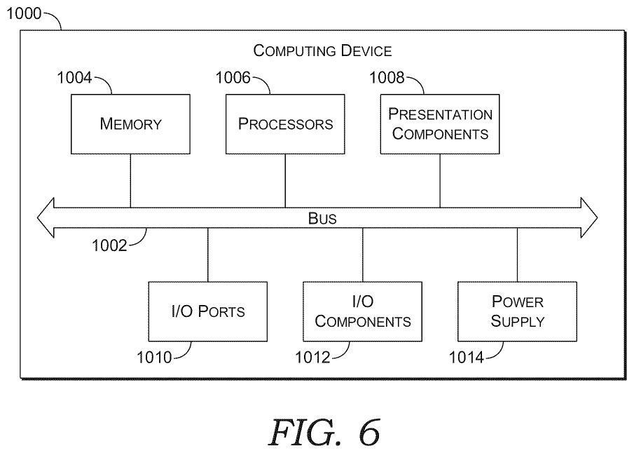

Generally, server 102 is a computing device that implements functional aspects of operating environment 100, such as one or more functions of container optimizer 112 to generate an optimal packing solution of packages within a container. One suitable example of a computing device that can be employed as server 102 is described as computing device 1000 with respect to FIG. 6. In implementations, server 102 represents a back-end or server-side device.

Computing device 104 is generally a computing device that may be used to interface with server 102. Computing device 104 may be used to provide container data 122, and/or package data 124 for determining optimal arrangements of packages within containers. In aspects, a three-dimensional representation of packages within a container is output at computing device 104.

As with other components of FIG. 1, computing device 104 is intended to represent one or more computing devices. One suitable example of a computing device that can be employed as computing device 104 is described as computing device 1000 with respect to FIG. 6. In implementations, computing device 104 is a client-side or front-end device. While the example architecture illustrated in FIG. 1 illustrates functions of container optimizer 112 being performed by server 102, it will be understood that this is just one example, and there may be more or fewer functions of container optimizer 112, which may be employed in various orders.

It is further noted that, in some implementations of the technology, functions of container optimizer 112 may be performed by other components of FIG. 1, or by components not shown. As an example, in some implementations, computing device 104 may be used to perform functions of container optimizer 112 in lieu of or in combination with server 102. The illustrated drawing is but one example used to aid in describing an aspect of the technology.

Quantum annealer 108 may generally comprises an analog quantum computing device, such as those suitable for performing quantum annealing. As will be further described, quantum annealer 108 may receive instructions from other components of FIG. 1 for solving a quantum problem, such as an optimization problem. Quantum annealer 108 may be configured to determine or receive a quantum problem and find an optimal or near-optimal solution to the problem through an annealing process, such as quantum annealing process 500. Quantum annealer 400 represents an example quantum annealer 400 that may be suitable as quantum annealer 108.

Generally, a quantum annealer, such as quantum annealer 108, exports several solvers. The mathematical equations may be converted to a form called QUBO (Quadratic Unconstrained Binary Operation), as is further described. The container optimizer 112 can use one of the available solvers to run on quantum annealer 108. To describe the problem to the annealer, CQMs (Constrained Quadratic Models) can be used. For instance CQM may support up to 100,000 constraints in some cases. COM supports integer and real variables.

When the number of packages is large, however, the number of constraints that are to be considered for packing increases exponentially. In some cases, the maximum number of constraints can be exceeded. In order to avoid that, the optimization problem can be divided into several sub-optimization problems. For example, the optimization problem can be divided into a sub-optimization problem based on packages intended for the same offload location. To solve this sub-optimization problem, the appropriate ratio of packages to the containers can be selected.

The ratio of packages to containers may be determined by measuring, or otherwise accessing, the weight/volume utilization of the containers when the optimizer optimally packs the packages; using the weight/volume unitization to arrive at the number of containers that could potentially be needed to pack the number of packages; allocating the determined number of containers for the packages and frame the allocation as a separate problem, which is sent to the quantum annealer. Packages matching the SPL code can be used to pack the selected containers. The SPL code and the offload location can be combined to arrive at the containers needed for the packages.

The packages and containers, thus segregated, form several sub-optimization problems that can be solved asynchronously by the quantum annealer. The final solution can then be combined and presented, such as via computing device 102, as a three-dimensional model illustrating the packages in the container according to the optimal packing arrangement. This method ensures that the constraint limit is not hit, and since the sub-optimization problems are solved asynchronously, the solution time is improved.

As illustrated, the example container optimizer 112 comprises sub-optimization problem generator 114, constraint and objectives determiner 116, quantum annealer invoker 118, and solution combiner 120. In general, container optimizer 112 may access data, such as container data 122 and package data 124. Container data 122 may include, for example, data related to the container, such as size, shape, weight requirements, container weight, volume, boundary location of walls within the container (i.e., vehicle type requirements, or other like data), and container restrictions. Package data 124 may include, for example, data related to the packages to be packed in the containers and delivered by the vehicles, such as package dimensions (e.g., width, length, or volume); package weight; package restrictions; or other like data. Container data 122 and package data 124 may be provided and stored in database 106. In an aspect, the data is provided by computing device 104. Other components may provide this data as well. Container optimizer 112 may access database 106 to retrieve container data 122 and package data 124 for use by its components in determining the arrangements of packages within containers using sub-optimization problems solved by a quantum annealer.

A container in the context of shipping refers to a vessel designed to hold and transport goods by a vehicle, such as land, sea, or air vehicle. In some cases, containers have irregular shapes. In some cases, the container shape is specific to transport by a particular type of vehicle, such as unit load devices designed for specific aircraft. Containers are geometric in shape and can be defined in terms of dimensions, such as length, height, and width for one or more faces of the container. Containers include a volume defined by their shape and measured by their dimensions. The base of a container generally refers to the lowest surface or boundary that encloses the space within the container from below.

Container restrictions are generally intended to refer to a set of guidelines or conditions imposed on the utilization and transportation of certain containers. Examples of such restrictions include weight restrictions, where a container's weight must not exceed the maximum load capacity. Dimensional restrictions are also common, ensuring that containers conform to standard sizes for ease of handling, stacking, and transportation across different modes. Material restrictions may dictate the type of material a container is made of, especially when transporting hazardous or reactive materials. Structural integrity is crucial, and containers must meet certain standards to ensure they can withstand the rigors of transit, including the stresses of stacking and handling. Carrier-specific restrictions could further stipulate the conditions under which a carrier will accept containers for transport, encompassing factors like security seals, proper labeling, and documentation. These are some example container restrictions, and there may be other container restrictions in practice. As used herein, a package refers to an item or a group of items designated to be transported from one location to another. The term package encompasses any unit for transit, including a single unit or a group of units secured together.

In general, package restrictions refer to the set of rules or conditions imposed on the packaging, handling, and transportation of goods and generally relate to safety, compliance, and delivery efficiency. Examples of such restrictions include vehicle restrictions, where hazardous materials might be confined to ground or sea transport avoiding air transit, or weight and size limitations dictating the mode of transport for excessively heavy or oversized packages. Contents restrictions identify restrictions based on the content of the packages. For example, content restrictions come into play with perishable goods demanding swift transit or temperature-controlled environments, and certain commodities being restricted or prohibited due to international laws. Co-transportation restrictions emerge when certain goods, like food items and chemicals, are deemed incompatible for joint transport due to risks of cross-contamination or reactions. Handling type restrictions necessitate specific handling procedures for packing, and may include crush restrictions where packages must be placed in a manner that prevents crushing, such as restrictions on stacking. Orientation restrictions generally relate to orientation requirements for packages, requiring a specific orientation to prevent spillage or damage. Destination or transit location restrictions may limit the routes certain packages may take or the final destinations at which certain packages can arrive. For example, destination and transit location restrictions might be shaped by trade embargoes, sanctions, or import/export restrictions imposed by the involved local jurisdictional laws. Lastly, carrier-specific restrictions reflect individual carriers' policies regarding what they will transport and under what conditions. These are some example package restrictions, and there may be other package restrictions in practice.

As noted, the technology may be used to determine the optimal arrangement of packages within container using container optimizer 112. In an aspect of the technology, container optimizer 112 determines or otherwise accesses the number of and type of containers in which packages will be arranged. As an example, to determine the number and type of containers, the number of available slots may initially be determined. For instance, certain vehicles have a limited number of slots for accepting containers for transport. This may be received or may be determined based on the vehicle type. In an aspect, the number of slots is provided by an input JSON file. In an aspect, the number of slots can be determined based on the vehicle type and the container restrictions by determining the container restrictions are compatible with the vehicle type.

Given the large amount of input data that may be provided to determine the optimal arrangement of packages within containers, container optimizer 112 may determine a number of sub-optimization problems, which may limit the number of applied constraints and allow the quantum annealer to solve larger problems than it otherwise would be able to given the large number of constraints determined by the input data.

To do so, container optimizer 112 can employ sub-optimization problem generator 114 to generate sub-optimization problems. Sub-optimization problems can be generated by grouping together the data inputs, including container data 122 and package data 124, such as the package dimensions, package weight, container volume, container restrictions, and so forth. The data can be grouped based on a number of factors. One example factor that can be used for grouping the data to generate sub-optimization problems includes destination location. That is, each of the packages may be grouped based on a common destination location. For example, a first sub-optimization problem may include the package data 124 for packages having a first destination location, while a second optimization problem may include the package data 124 for packages having a second destination location different from the first. Other criteria may be used for selecting packages for generating sub-optimization problems, such as package restrictions, e.g., co-transportation restrictions, container restrictions, and restrictions for certain types of transport vehicles.

In an aspect, sub-optimization problem generator 114 determines and assigns a container to each sub-optimization problem. The container may be determined based on the weight and volume of the packages each respective sub-optimization problems. For example, one sub-optimization problem has 70 packages while another sub-optimization problem has 30 packages (e.g., based on each group of packages having a different common designation). Thus, containers may be selected based on the container restrictions complying with the package data for each group. For instance, the aggregate weight and volume for each of the package groups may be less than the maximum weight and volume restrictions for each container.

Constraint and objectives determiner 116 can be employed to determine the constraints and objectives for each of the groups. That is, different groups of packages will have different constraints. As a general matter, larger groups of packages will typically have a larger set of constraints, which is why it may be beneficial to break the optimization problem into several sub-optimization problems). For example, the packages in one group may have different orientation constraints, stacking constraints (to prevent crushing), container constraints (e.g., different size and shape containers), different priority levels of packages, different revenue levels of packages, and so forth. The constraints applying to the subgroup of packages based on the package data are selected for use by the quantum annealer 108 when solving the optimization problem.

Each group of packages may correspond to an objective function, which may be generated based on any one or more objectives, such as minimizing shipment time, lowering shipping costs, reducing fuel consumption, reducing carbon dioxide output, and so forth. In one aspect, one objective function can be generated and used for all of the sub-optimization problems. In another aspect, an objective function for each of the sub-optimization problems may be generated. For instance, it may be desirable to optimize for reduced fuel consumption on packages traveling to certain destinations, and maximizing revenue for another destination, or a combination of both. The objectives can be determined and used to formulate one or more objective functions that will be solved by quantum annealer 108. The objective function can be generated in QUBO or Ising form, or another format solvable by a quantum computing device, as will be further described.

As an example, for determining the optimal arrangement of packages within a container, certain spatial constraints may apply. For example, a constraint to prevent overlapping packages can be applied. Another constraint that can be applied are the container boundary constraints. Examples of such as provided below:
Non-overlapping constraints can include

$$( 2 - {p}_{ij} {p}_{kj} - {b}_{ik 1} ) {\sum }_{c = 1}^{n} {L}_{c} + {x}_{i} + {x}_{i}^{′} - {x}_{k} \leq 0$$

$$( 2 - {p}_{ij} {p}_{kj} - {b}_{ik 2} ) {W}_{j} + {y}_{i} + {y}_{i}^{′} - {y}_{k} \leq 0$$

$$( 2 - {p}_{ij} {p}_{kj} - {b}_{ik 3} ) {H}_{j} + {z}_{i} + {z}_{i}^{′} - {z}_{k} \leq 0$$

$$( 2 - {p}_{ij} {p}_{kj} - {b}_{ik 4} ) {\sum }_{c = 1}^{n} {L}_{c} + {x}_{k} + {x}_{k}^{′} - {x}_{i} \leq 0$$

$$( 2 - {p}_{ij} {p}_{kj} - {b}_{ik 5} ) {W}_{j} + {y}_{k} + {y}_{k}^{′} - {y}_{i} \leq 0$$

$$( 2 - {p}_{ij} {p}_{kj} - {b}_{ik 6} ) {H}_{j} + {z}_{k} + {z}_{k}^{′} - {z}_{i} \leq 0$$

Container boundary constraints can include:

$${x}_{i} + {x}_{i}^{′} - {\sum }_{c = 1}^{j + 1} {L}_{c} \leq ( 1 - {p}_{ij} ) {\sum }_{c = 1}^{m} {L}_{c} ;$$

$${y}_{i} + {y}_{i}^{′} - {W}_{j} \leq ( 1 - {p}_{ij} ) {W}_{j} ; and$$

$${z}_{i} + {z}_{i}^{′} - {H}_{j} \leq ( 1 - {p}_{ij} ) {H}_{j} .$$

Here, the parameters are:
mᵢ—Mass (weight) of package i;
Vⱼ—Volume of container j;
Hⱼ—Height of the container j;
m—Number of containers;
n—Number of packages;
sᵢ—Score of the package i. Maximum score can be assumed to be 100. The higher the score, the higher the probability of the package being assigned to a container, for example;
Mⱼ—Max gross weight (denoted by Mass) the container j supports;
Kᵢ—List of rotations allowed for the package i (1<=k<=6);
b_{ikq}—Binary variable that returns the relative position q€Q between items i, k. 1<=Q<=6;
1->if item i is to the left of k, 2->if item i is behind k, 3->item i is below k, 4->item i is to the right of k, 5->item i is in front of k, 6->item i is above k;
P_{ezel}—Set of those packages that should be placed in different containers;
P_{inc}—Set of those packages that are to be placed in the same container;
P_{load}—set of packages that must be loaded;
lᵢ, wᵢ, hᵢ—Length, width, and height of package i;
Lⱼ, Wⱼ, Hⱼ—Length, width, and height of the container j;
eᵢ—the package is not assigned to any container; and
(xᵢ′,yᵢ′,zᵢ′)—Computed coordinates of the rear right top vertex of package i after the orientation has been chosen.
Decision variables can include:
Uⱼ—is set if container j is used;
pᵢⱼ—is set if package i is assigned to container j;
rᵢₖ—If the package i is in the orientation k, where 1<=k<=6; and
(xᵢ,yᵢ,zᵢ)—Location of the front left bottom vertex of package i.

Quantum annealer invoker 118 can be used to solve each sub-optimization problem by invoking quantum annealer 108, methods of which will be further described. That is, the container data 122 and the package data 124 for each subgroup, along with the objective functions and constraints, can be provided to quantum annealer 108 for annealing solutions to the respective sub-optimization problems. Quantum annealer 108 outputs a solution for each sub-optimization problem. The solutions may be provided, such as via computing device 104. In an aspect, the sub-optimization problems are annealed by the quantum annealer asynchronously.

In some aspects, the solutions to the sub-optimization problems are combined by solution combiner 120 and provided as a combined solution. Solution combiner 120 may combine the solutions by aggregating package identifiers identifying packages along with their determined orientation. For example, given two subgroups: group 1: {1, 3, 5, 7, 9, . . . } and group 2: {2, 4, 6, 8, 10, . . . }, solution combiner 120 may identify each of the packages identifiers identifying a specific package and the location, as determined by the quantum annealer, and provide this as combined solution identifying each of the packages and their locations and orientations within the containers to which they are assigned.

In an aspect, the output solution comprises a three-dimensional illustration of the container and the locations and orientation of each of the packages. This may be extracted and determined from a data artifact describing the locations (e.g., described in terms of a coordinate system) of the packages relative to the container or other packages. The solutions to the sub-optimization problems or the combined solution may be provided as output via computing device 104.

The data artifact may also be consumed by a range of automation technologies including but not limited to industrial robot arms, augmented reality devices, and inventory management solutions. The step-by-step output provides a clear and visual representation of the solution. The output typically includes an image and details about each package and where it is loaded inside the container relative to other packages previously loaded. For instance, the output may be used to render a three-dimensional display to show the location of a package within the container, which may be done in augmented or virtual reality. In another example, the output may be used by robot arms or unmanned delivery system to place the packages within the container at the location specified by the coordinates.

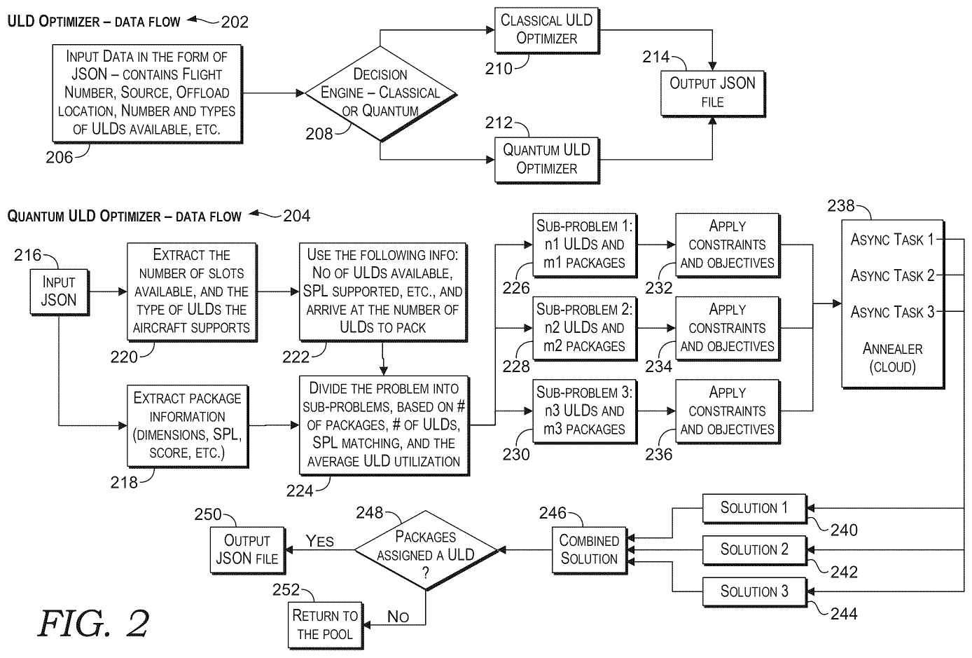

FIG. 2 provides a flow diagram of an example process that can be performed by components of FIG. 1. The figure is intended to represent only one example, while the described technology may also perform other methods and processes not show or in order not described.

A container optimizer data flow is illustrated at 202. At 206, vehicle information, container data, and package data is provided. This can be provided in a JSON format. At 208, a decision is made to perform the analysis using a classical computing device or a quantum computing device. The decision may be made based on a size of the solution space. The solution space can be determined or estimated from the vehicle information, container data, and package data provided (e.g., the number of routes, the number of packages, the number of destination locations, the package and container restrictions, and so forth). If the solution space is such that its size would require a threshold value of computational power, a decision is made whether to perform the computation using a classical computing device or a quantum computing device. If a classical computing device (such as server 102 of FIG. 1) is to be used based on the threshold computational requirements, the process proceeds to use a classical optimizer at 210. If a quantum computing device (such as quantum annealer 108 of FIG. 1) is to be used based on the threshold computational requirements, the process proceeds to use a quantum optimizer at 212. A JSON file is output at 214.

If a quantum optimizer is used, the process can proceed to 204, which illustrates a quantum container optimizer workflow. At 216, the JSON file is input (such as by computing device 104 of FIG. 1). At 218, package information is extracted from the JSON file (e.g., number of packages, dimensions, weight, and package restrictions). At 220, the number of slots is determined or otherwise accessed (e.g., from data indicating the number of slots for vehicles provided in the JSON file). The information extracted at 218 and 220 is used to divide the optimization problem into sub-optimization problems (such as by sub-optimization problem generator 114 of FIG. 1). In doing so, packages may be grouped together into different sub-optimization problems. As mentioned, one technique for doing this is based on delivery location, although others can be used in lieu of or in addition to the delivery location. In some cases, the optimization problem is divided based on average container utilization (e.g., the average volume of the containers for the slots taken by the total volume of the packages across the containers).

As illustrated in this example, there are three sub-optimization problems generated 226, 228, and 230 (such as by sub-optimization problem generator 114 of FIG. 1). However, it will be realized this is provided for the sake of discussion, and that any number of sub-optimization problems may be generated based on the dataset. In an example, the number of sub-optimization problems is determined by the number of slots available for containers on vehicle(s). In an aspect, the number of sub-optimization problems is determined by a number of constraints corresponding to each of the groups of packages relative to the capacity of the quantum annealer.

Objectives and constraints are determined or otherwise accessed (such as by objectives and constraints determiner 116 of FIG. 1) for each of the sub-optimization problems. Here, there are 226, 228, and 230 sub-optimization problems respectively corresponding to objectives and constraints 232, 234, and 236. These are provided to an annealer (such as by quantum annealer invoker 118 of FIG. 1). The annealer may anneal the sub-optimization problems asynchronously. This is beneficial because it reduces the number of constraints that the annealer has to process when determining an optimal packaging arrangement of the packages. This is illustrated as 238. It is also beneficial because it may allow for parallel processing, thus solving the sub-optimization problems more rapidly than would occur without the ability to process the problems in parallel.

In an aspect, the annealer (such as quantum annealer 108 of FIG. 1) outputs an optimal packing arrangement for the packages for each of the subgroups 226, 228, and 230, illustrated respectively as 240, 242, and 244. As such, optionally, the separate solutions may be combined into a combined solution at 246 (such as by solution combiner 120 of FIG. 1). Packages that are not assigned through the annealing process can be returned to a pool at 252 for further assignment, either manually, by a classical device, or as part of another group using the quantum device. For the assigned packages, or if all packages have been assigned, at 248, a decision can be made to output the solution. The solution can be output in the form of a JSON file, for example as shown by 250. As noted, the output may be a consumable format identifying the package locations within the vehicles, and which may be provided to a three-dimensional model generator, virtual or augmented reality display, or to robotic arms or autonomous systems for automatic placement in the containers, or another like output.

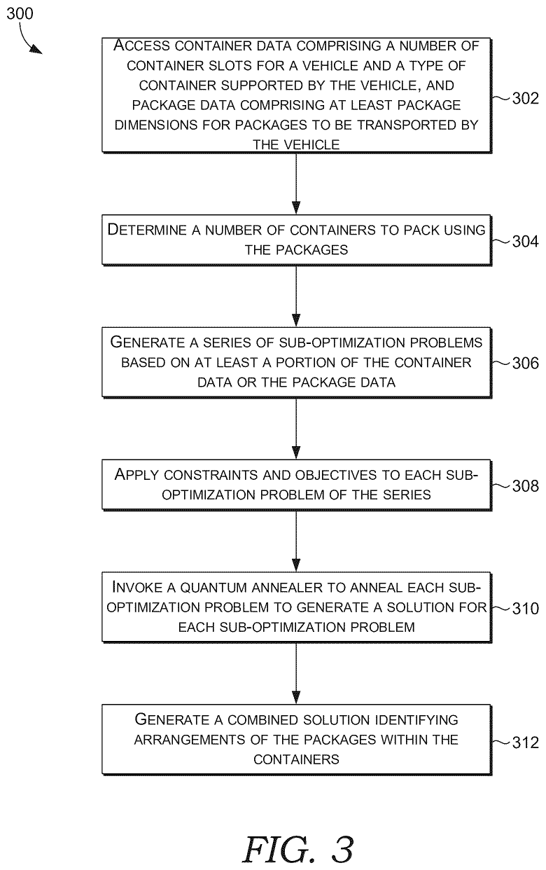

With reference back to FIG. 3, a block diagram is provided illustrating an example method 300 for determining an optimal arrangement of packages within a container. Each block of method 300 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. Method 300 may be implemented in whole or in part by components of operating environment 100.

In block 302, method 300 accesses container data comprising a number of container slots for a vehicle and a type of container supported by the vehicle, and package data comprising at least package dimensions for packages to be transported by the vehicle.

In block 304, method 300 determines a number of containers to pack using the packages.

In block 306, method 300 generates a series of sub-optimization problems (such as by sub-optimization problem generator 114 of FIG. 1) based at least on common destinations for the packages. Another parameter may be used to determine the sub-optimization problems, including any vehicle information, package data, or container data. For example, in another aspect, package priority may be used. In another aspect, the average container volume may be used. In another aspect, the number of sub-optimization problems is determined based on the number of container slots. In some cases, the sub-optimization problems are based on a threshold number of constraints that can be used with the annealer. The number of sub-optimization problems can be determined by any of these aspects individually or in combination.

In block 308, method 300 applies constraints and objectives (such as by constraints and objectives determiner 116 of FIG. 1) to each sub-optimization problem of the series. In block 310, method 300 invokes a quantum annealer (such as by quantum annealer invoker 118 of FIG. 1) to anneal each sub-optimization problem to generate a solution for each sub-optimization problem.

In block 312, method 300 generates a combined solution (such as by solution combiner 120 of FIG. 1) identifying arrangements of the packages within the containers. In an aspect, the method outputs the solutions to the sub-optimization problems separately (e.g., without combining). In some cases, a three-dimensional model is rendered illustrating the arrangement of the packages within the container. In some cases, the data output is provided to an augmented or virtual reality display device, or to a robotic system that places the packages in the container according to the agreement.

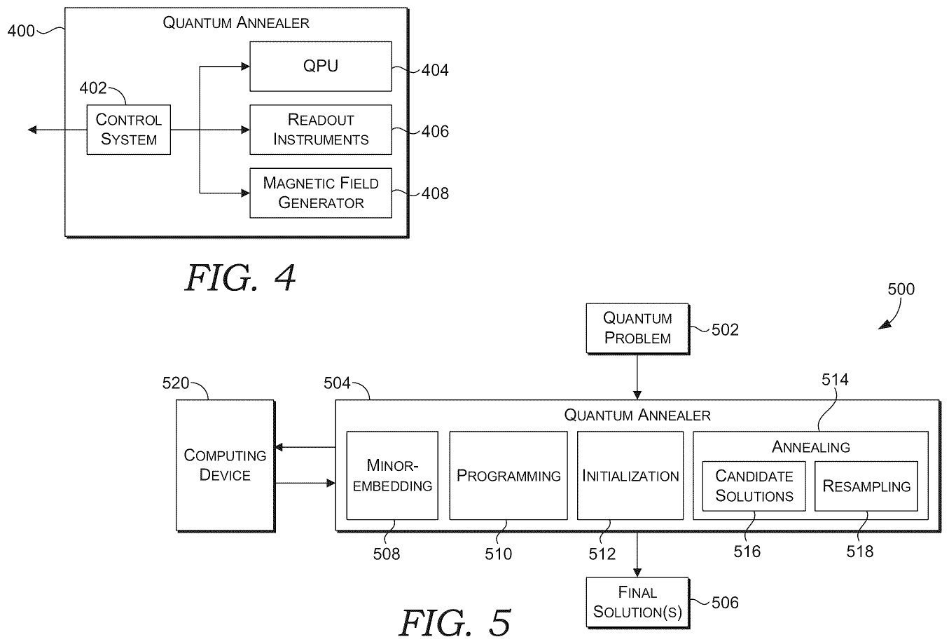

FIG. 4 illustrates an example quantum annealer 400 that may be employed with aspects of the technology. As FIG. 4 is only one example, other quantum annealers may be employed. Some examples of which may include D-Wave Systems annealers, which employ superconducting qubits to find the optimal or near-optimal ground state solutions to solving proposed optimization problems. As such, other quantum annealers having more of fewer components, and having different arrangements or architectures, may be used. It is again, noted, that the illustrated quantum annealer 400 in FIG. 4 is only an example and is provided to aid in the description of the technology. It is not intended to limit the technology to one type of quantum annealer, or any type of quantum computing system. In the example provided, quantum annealer 400 comprises control system 402 operationally coupled to QPU 404, readout instruments 406, and magnetic field generator 408.

Control system 402 of quantum annealer 400 generally interfaces with components of quantum annealer 400, including QPU 404, readout instruments 406, and magnetic field generator 408, among other components not illustrated. For instance, control system 402 may operationally control or receive information from such components. Control system 402 facilitates quantum annealing functions, for example, translating a quantum problem into physical aspects of the QPU 404; setting parameters of the quantum annealing process, including the biases and couplings among qubits; managing the annealing schedule, a predefined protocol guiding the system from the initial to the final Hamiltonian that finds the global minimum representing the quantum problem's solution; among other functions and operations.

During the annealing process, control system 402 generates and delivers signals to the qubits and couplers of QPU 404, manipulating their states and interactions in accordance with the quantum problem being executed. In aspects, as the annealing process concludes, control system 402 may oversee the readout of qubits' states in coordination with readout instruments 406, thus translating quantum information into classical data that can be interpreted by classical computing devices.

Control system 402 may provide an interface for external systems by communicatively coupling with classical computing devices, such as computing device 1000 of FIG. 6, to facilitate the input of problem definitions and the output of solutions. Control system 402 itself may comprise a classical computer processor that reads from memory to execute computer-readable instructions stored thereon.

QPU 404 (i.e., a Quantum Processing Unit is the core of quantum computational activity. QPUs may house an array of qubits (quantum bits), which may exist in a superposition of states. QPU 404 facilitates quantum operations that exploit quantum phenomena like superposition and entanglement to solve quantum problems. Within QPU 404, couplers manage interactions between the qubits and form the basis for quantum logic gates and multi-qubit operations for quantum algorithms. Although not illustrated, QPU 404 may be cooled by a cooling device of quantum annealer 400 and shielded from other external components or interferences, helping to maintain quantum coherence.

QPU 404 may comprise control lines, across which signals are transmitted that guide quantum operations of QPU 404. QPU 404 may couple to readout instruments 406 to translate quantum states into classical data and communicate control system 402. Readout instruments 406 may include analog-to-digital converter that translates the quantum state of the qubits to the digital space, thereby identify the quantum state of the qubits in a manner readable by a classical machine, thus providing a candidate solution for the quantum problem to control system 402. In aspects, analog signals captured from qubit measurements may be amplified and filtered to sift through and eliminate noise.

Qubit states may be manipulated by control system 402 employing magnetic field generator 408. By varying the strength and orientation of the magnetic field, control system 402 can tailor the energy landscape that the qubits navigate during the annealing process. This magnetic field induces a bias on each qubit, influencing its tendency to take on a particular state during the annealing process.

The construction of quantum computers can be approached through various paradigms and hardware setups, among which gate-based quantum computing and adiabatic quantum computation (AQC) are predominant. Gate-based computing involves executing computations by applying a series of unitary gates to quantum bits (qubits), which are then measured at the computation's conclusion. Conversely, AQC starts with a many-qubit quantum state prepared as a simple Hamiltonian's ground state, which, through adiabatic time evolution, transitions to a final Hamiltonian, encoding the solution to a targeted optimization problem. AQC and gate-based quantum computing are polynomially equivalent since quantum circuits can be depicted as a time-dependent Hamiltonian with a maximal polynomial overhead.

Quantum annealing (QA) is closely related to AQC. QA is a variant of the AQC model, employed when adiabatic conditions are unfulfilled, leading to a heuristic variational quantum algorithm. This technique is adept at identifying the ground state of Ising models, an NP-hard challenge. NP-hard and NP-complete combinatorial optimization problems can be transformed to forms suitable for quantum annealers, either framed in Ising form or as a Quadratic Unconstrained Binary Optimization (QUBO) problem. For instance, these optimization problems can be transformed to Ising form using a {−1, 1} basis and spin variables or as a QUBO problem using the {0, 1} basis and binary variables. In QA, solving a optimization problem entails progressing through multiple stages, with the specifics of each stage being influenced by the kind of qubits utilized, the adiabatic protocol implemented, and other engineering factors.

FIG. 5 illustrates an example quantum annealing process 500 utilizing quantum annealer 504. FIG. 5 is only one example provided as an aid for understanding and using the technology described herein. At a high level, quantum annealer 504 receives an input, illustrated using example quantum problem 502 and outputs candidate final solution(s) 506. Quantum annealing process 500 illustrates processes 508-518 that may be performed by or for quantum annealer 504 to determine final solution(s) 506. For instance, some aspects maybe performed by a classical computing device 520 communicatively coupled to quantum annealer 504. As an example, the classical computing device 520 may be used to facilitate aspects of minor-embedding process 508, programming process 510, initialization process 512 in coordination with quantum annealer 504. Computing device 1000 of FIG. 6 is an example suitable for use as computing device 520. Computing device 520 may interface with a control system of quantum annealer 504, which may be the same or separate computing devices. As with other aspects of FIG. 5, each of the process is intended to represent an example, and nothing is intended to restrict the technology to a particular process or machine.

Having this in mind, quantum problem 502 may include optimization problems in various forms, such as QUBO model and an Ising model. Real-world problems can be broken down into objectives and constraints. Optimization problems can be represented by the following QUBO form:

$$min ( {\sum }_{i} {a}_{i} {x}_{i} + {\sum }_{i} {\sum }_{j > i} {b}_{i , j} {x}_{i} {x}_{j} + c )$$

The binary variables xᵢ and xⱼ may take values from {0, 1}, and aᵢ, bᵢ, and c are constraints defined by the problem to be solved.

Optimization problems may be expressed by the Ising model, taking the following form:

$$min ( {\sum }_{i} {h}_{i} {s}_{i} + {\sum }_{i} {\sum }_{j > i} {I}_{i , j} {s}_{i} {s}_{j} )$$

The binary variables sᵢ and sⱼ may take values from {−1, 1}, whereas J_{i,j} is the interaction of two adjacent sites <i,j> for a given magnetic field hᵢ. The QUBO form and the Ising form may be translated from one another in some cases.

The models may be represented by a logical graph. For a QUBO problem each node may correspond to a variable, which may correspond to qubits. Edges in this graph represent the interaction terms between pairs of variables, derived from the quadratic terms in the QUBO expression. Similarly, for an Ising model, each node may represent a spin and correspond to qubits. Edges may denote the interactions between pairs of spins (or variables) as dictated by the interaction terms in the Ising model's energy expression. Such models may be formulated or represented as logical graph and provided as a quantum problem 502 to quantum annealer 504.

During minor-embedding process 508, the local graph of the initial quantum problem 502 may be translated onto the physical hardware of the quantum processing unit (QPU). Here, select sets of physical qubits represent the nodes, while couplings between the qubits correspond to the interaction of the logical variables

During programming process 510, the quantum annealer 504 may be programmed with the parameters that define the problem. This problem may be the final Hamiltonian. The final Hamiltonian is a quantum mechanical operator that represents the problem to be solved in a form that quantum annealer 504 understands. It is derived from the logical representation of the problem (such as the QUBO formulation or the Ising model). The objective is to find the state (or configuration of qubits) that minimizes its energy as this corresponds to the solution of quantum problem 502.

The programming process 510 may comprise setting weights for each qubit bias and coupler strength. Qubits in quantum annealer 504 can have a bias, for example, a term in the final Hamiltonian that represents an external magnetic field acting on the qubit. Setting the bias on a qubit influences its tendency to take a particular state (0 or 1). Weights for the qubit bias may be set based on the problem formulation to guide quantum annealer 504 toward the desired solution. Couplers may comprise elements in quantum annealer 504 that control the interaction between pairs of qubits. The strength of a coupler determines the extent to which the state of one qubit influences the state of another. Coupler strength may be set to represent the interactions between variables in quantum problem 502.

During initialization process 512, an initial Hamiltonian may be defined. The initial Hamiltonian may be constructed to have an achievable lowest energy (ground state) configuration. The design may serve as a starting point for the annealing process 514.

Through annealing process 514, quantum annealer 504 gradually transitions from the initial Hamiltonian to the final Hamiltonian (which was defined during the programming phase and represents the actual problem to be solved). Generally, as the system transitions, quantum annealer 504 attempts to maintain the lowest-energy configuration, and ideally end in the ground state of the final Hamiltonian, which corresponds to the solution of the quantum problem 502. In some cases, annealing process 514 can also be combined with a reverse annealing phase, which initializes quantum annealer 504 with a known (classical) solution and searches the state space around this local optimum.

At the end of annealing process 514, quantum annealer 504 provides candidate solutions 516 to quantum problem 502. Here, the qubits in the QPU are in an eigenstate or a superposition of eigenstates with respect to the final Hamiltonian. An eigenstate refers to a state with a well-defined energy and represents a possible solution. A superposition of eigenstates refers to multiple eigenstates at once, each representing a potential solution to the problem. Each qubit's spin (either up or down) is read out, and the collection of spin values represents a candidate solution to quantum problem 502.

Quantum annealing is heuristic and the exact optimal solution (ground state of the final Hamiltonian) may not be found in every run. Instead, the candidate solutions 516 provide a good enough solution in a reasonable amount of time. Naturally, there's a non-zero probability of ending up in a non-optimal solution due to various quantum phenomena like tunneling and thermal fluctuations. As such, annealing process 514 may undergo resampling 518, which repeats the annealing process 514 in an effort to identify a better solution than prior candidate solutions 516. Each resampling process provides a new opportunity for the quantum annealer 504 to explore the solution space and possibly find a better or different candidate solution. Resampling 518 may be performed as many times as desired, as time and continued benefit allow. By comparing candidate solutions 516, the best candidate solution or even a variety of candidate solutions may be chosen as solutions to quantum problem 502 and output as final solution(s) 506.

Having described an overview of some embodiments of the present technology, an example computing environment in which embodiments of the present technology may be implemented is described below in order to provide a general context for various aspects of the present technology. Referring now to FIG. 6 in particular, an example operating environment for implementing embodiments of the present technology is shown and designated generally as computing device 1000. Computing device 1000 is but one example of a suitable computing environment and is not intended to suggest any limitation as to the scope of use or functionality of the technology. Computing device 1000 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 6, computing device 1000 includes bus 1002, which directly or indirectly couples the following devices: memory 1004, one or more processors 1006, one or more presentation components 1008, input/output (I/O) ports 1010, input/output components 1012, and illustrative power supply 1014. Bus 1002 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 6 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 6 and with reference to “computing device.”

Computing device 1000 typically includes a variety of computer-readable media. Computer-readable media can be any available media that can be accessed by computing device 1000 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1000. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1004 includes computer-storage media in the form of volatile or non-volatile memory. The memory may be removable, non-removable, or a combination thereof. Example hardware devices include solid-state memory, hard drives, optical-disc drives, etc. Computing device 1000 includes one or more processors that read data from various entities, such as memory 1004 or I/O components 1012. Presentation component(s) 1008 presents data indications to a user or other device. Example presentation components include a display device, speaker, printing component, vibrating component, etc.

I/O ports 1010 allow computing device 1000 to be logically coupled to other devices, including I/O components 1012, some of which may be built in. Illustrative components include a microphone, joystick, game pad, satellite dish, scanner, printer, wireless device, etc. The I/O components 1012 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1000. Computing device 1000 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1000 may be equipped with accelerometers or gyroscopes that enable detection of motion. The output of the accelerometers or gyroscopes may be provided to the display of computing device 1000 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components of FIG. 1 can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to container optimizer 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving,” or “transmitting,” as facilitated by software or hardware-based buses, receivers, or transmitters” using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “computing device” is intended to refer to a classical computing device, such as computing device 1000 of FIG. 6. Other related terms, including “client device,” “server,” and the like are similarly intended to refer to a classical computing device. Terms that include “quantum” are intended to refer to a quantum computing device, such as a quantum annealer. An example quantum computing device is illustrated and described with respect to FIG. 4.

An optimal solution (also referred to as optimal packing arrangement), as described herein is intended to be the most favorable solution derived from a set of potential solutions generated within the constraints of available processing power and time. This solution minimizes or maximizes the defined objective(s) based on the data and algorithms employed during the computational process, such as the annealing process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some aspects of the technology that may be practice from the foregoing description include, but are not limited to, the following:
Aspect 1: A computerized method comprising: accessing container data comprising a number of container slots for a vehicle and a type of container supported by the vehicle, and package data comprising at least package dimensions for packages to be transported by the vehicle; determining a number of containers to pack using the packages; generating a series of sub-optimization problems based on at least a portion of the container data or the package data; applying constraints and objectives asynchronously to each sub-optimization problem of the series; invoking a quantum annealer to anneal each sub-optimization problem to generate a solution for each sub-optimization problem; and generating a combined solution identifying an optimal packing arrangement of the packages within the containers.
Aspect 2: A system comprising: a quantum annealer; at least one processor; and one or more computer storage media storing computer readable instructions thereon that when executed by the at least one processor cause the at least one processor to perform operations comprising: determining a number of containers to pack using the packages; generating a series of sub-optimization problems based on at least a portion of the container data or the package data; applying constraints and objectives asynchronously to each sub-optimization problem of the series; invoking the quantum annealer to anneal each sub-optimization problem to generate a solution for each sub-optimization problem; generating a combined solution identifying an optimal packing arrangement of the packages within the containers; and outputting the combined solution as a three-dimensional visualization of the containers illustrating the packages packed within the containers according to the optimal packing arrangement identified in the combined solution.
Aspect 3: One or more computer storage media storing computer-readable instructions thereon that when executed by a processor cause the processor to perform operations comprising: determining a number of containers to pack using the packages; generating a series of sub-optimization problems based on at least a portion of the container data or the package data; applying constraints and objectives asynchronously to each sub-optimization problem of the series; invoking a quantum annealer to anneal each sub-optimization problem to generate a solution for each sub-optimization problem; generating a combined solution identifying an optimal packing arrangement of the packages within the containers; and communicating the combined solution to be consumed by an industrial robot arm, an augmented reality device, or an inventory management solutions.
Aspect 4: Any of Aspects 1 or 3, further comprising outputting the combined solution as a three-dimensional visualization of the containers illustrating the packages packed within the containers according to the optimal packing arrangement identified in the combined solution.
Aspect 5: Any of Aspects 1-2 or 4, further comprising communicating the combined solution to be consumed by an industrial robot arm, an augmented reality device, or an inventory management solutions.
Aspect 6: Any of Aspects 1-5, wherein the at least a portion of the container data or the package data used to generate the series of sub-optimization problems comprises common destinations for the packages.
Aspect 7: Any of Aspects 1-6, wherein the at least a portion of the container data or the package data used to generate the series of sub-optimization problems comprises an average container volume.
Aspect 8: Any of Aspects 1-7, wherein the at least a portion of the container data or the package data used to generate the series of sub-optimization problems a number of container slots.
Aspect 9: Any of Aspects 1-8, wherein the sub-optimization problems are further generated based on a threshold number of constraints for the quantum annealer.
Aspect 10: Any of Aspects 1-9, wherein the quantum annealer asynchronously anneals each of the sub-optimization problems.

What is claimed is:

1. A computerized method comprising:
accessing container data comprising a number of container slots for a vehicle and a type of container supported by the vehicle, and package data comprising at least package dimensions for packages to be transported by the vehicle;
determining a number of containers to pack using the packages;
generating a series of sub-optimization problems based on at least a portion of the container data or the package data;
applying constraints and objectives asynchronously to each sub-optimization problem of the series;
invoking a quantum annealer to anneal each sub-optimization problem to generate a solution for each sub-optimization problem; and
generating a combined solution identifying an optimal packing arrangement of the packages within the containers.

2. The method of claim 1, further comprising outputting the combined solution as a three-dimensional visualization of the containers illustrating the packages packed within the containers according to the optimal packing arrangement identified in the combined solution.

3. The method of claim 1, further comprising communicating the combined solution to be consumed by an industrial robot arm, an augmented reality device, or an inventory management solutions.

4. The method of claim 1, wherein the at least a portion of the container data or the package data used to generate the series of sub-optimization problems comprises common destinations for the packages.

5. The method of claim 1, wherein the at least a portion of the container data or the package data used to generate the series of sub-optimization problems comprises an average container volume.

6. The method of claim 1, wherein the at least a portion of the container data or the package data used to generate the series of sub-optimization problems a number of container slots.

7. The method of claim 1, wherein the sub-optimization problems are further generated based on a threshold number of constraints for the quantum annealer.

8. The method of claim 1, wherein the quantum annealer asynchronously anneals each of the sub-optimization problems.

9. A system comprising:
a quantum annealer;
at least one processor; and
one or more computer storage media storing computer readable instructions thereon that when executed by the at least one processor cause the at least one processor to perform operations comprising:
determining a number of containers to pack using the packages;
generating a series of sub-optimization problems based on at least a portion of the container data or the package data;
applying constraints and objectives asynchronously to each sub-optimization problem of the series;
invoking the quantum annealer to anneal each sub-optimization problem to generate a solution for each sub-optimization problem;
generating a combined solution identifying an optimal packing arrangement of the packages within the containers; and
outputting the combined solution as a three-dimensional visualization of the containers illustrating the packages packed within the containers according to the optimal packing arrangement identified in the combined solution.

10. The system of claim 9, wherein the at least a portion of the container data or the package data used to generate the series of sub-optimization problems comprises common destinations for the packages.

11. The system of claim 9, wherein the at least a portion of the container data or the package data used to generate the series of sub-optimization problems comprises an average container volume.

12. The system of claim 9, wherein the at least a portion of the container data or the package data used to generate the series of sub-optimization problems a number of container slots.

13. The system of claim 9, wherein the sub-optimization problems are further generated based on a threshold number of constraints for the quantum annealer.

14. The system of claim 9, wherein the quantum annealer asynchronously anneals each of the sub-optimization problems.

15. One or more computer storage media storing computer-readable instructions thereon that when executed by a processor cause the processor to perform operations comprising:
determining a number of containers to pack using the packages;
generating a series of sub-optimization problems based on at least a portion of the container data or the package data;
applying constraints and objectives asynchronously to each sub-optimization problem of the series;
invoking a quantum annealer to anneal each sub-optimization problem to generate a solution for each sub-optimization problem;
generating a combined solution identifying an optimal packing arrangement of the packages within the containers; and
communicating the combined solution to be consumed by an industrial robot arm, an augmented reality device, or an inventory management solutions.

16. The computer storage media of claim 15, wherein the at least a portion of the container data or the package data used to generate the series of sub-optimization problems comprises common destinations for the packages.

17. The computer storage media of claim 15, wherein the at least a portion of the container data or the package data used to generate the series of sub-optimization problems comprises an average container volume.

18. The computer storage media of claim 15, wherein the at least a portion of the container data or the package data used to generate the series of sub-optimization problems a number of container slots.

19. The computer storage media of claim 15, wherein the sub-optimization problems are further generated based on a threshold number of constraints for the quantum annealer.

20. The computer storage media of claim 15, wherein the quantum annealer asynchronously anneals each of the sub-optimization problems.
